(19) United States
(12) Patent Application Publication
(10) Pub. No.: US 2024/0193816 A1
(43) Pub. Date: Jun. 13, 2024

(54) METHOD AND APPARATUS FOR IMMERSIVE VIDEO ENCODING AND DECODING, AND METHOD FOR TRANSMITTING A BITSTREAM GENERATED BY THE IMMERSIVE VIDEO ENCODING METHOD

(71) Applicant: RESEARCH & BUSINESS FOUNDATION SUNGKYUNKWAN UNIVERSITY, Suwon-si (KR)

(72) Inventors: Eun Seok RYU, Seoul (KR); Soon Bin LEE, Seongnam-si (KR); Jong Beom JEONG, Yangju-si (KR)

(73) Assignee: RESEARCH & BUSINESS FOUNDATION SUNGKYUNKWAN UNIVERSITY, Suwon-si (KR)

(21) Appl. No.: 18/115,248

(22) Filed: Feb. 28, 2023

(30) Foreign Application Priority Data
Dec. 8, 2022 (KR) 10-2022-0170721

(51) Int. Cl. G06T 9/00; G06T 7/11; G06T 17/00; G06V 10/74

(52) U.S. Cl. CPC G06T 9/00; G06T 7/11; G06T 17/00; G06V 10/761

(57) ABSTRACT

Disclosed herein are an immersive image encoding/decoding method and apparatus, and a method for transmitting a bitstream generated by the immersive image encoding method. An immersive image encoding method according to the present disclosure, which is performed in an immersive image encoding apparatus, may include: grouping images for a virtual reality space into groups; calculating, based on view information, a view weight of each of the groups; and determining, based on the view weight, a bitstream level of the each of the groups.

### CROSS REFERENCE TO RELATED APPLICATION

The present application claims priority to a KR application 10-2022-0170721, filed Dec. 8, 2022, the entire contents of which are incorporated herein for all purposes by this reference.

### BACKGROUND OF THE INVENTION

### Field of the Invention

The present disclosure relates to a method for encoding and decoding an immersive image and, more particularly, to an immersive image encoding/decoding method and apparatus, which differentially adjust quality of bitstreams for immersive images based on degrees of contribution of the immersive images for views, and to a method for transmitting a bitstream generated by the immersive image encoding method.

### Description of the Related Art

Virtual reality services can generate full 360-degree images (or omni-directional images, 360-degree images or immersive images) in realistic or computer graphics (CG) formats and play such images on a personal VR unit like a head mounted display (HMD) and a smartphone and are also evolving to maximize senses of immersion and realism.

For 6 degrees of freedom (DoF) image streaming, which is well beyond simple 360-degree VR images, an image corresponding to every position and viewing angle of a viewer (or user) needs to be streamed using images and a depth map that are obtained from various views.

In order to provide an image corresponding to a user's view, a virtual view synthesizing process is performed where images (immersive images) for many views are synthesized and processed. The current MPEG-I adopts a method of processing and transmitting a plurality of images at once in order to reduce the number of video encoders/decoders required for processing the plurality of images.

However, as the method treats a plurality of images as a single image and thus cannot select a bitstream with a differential quality level, efficient bandwidth control is difficult in an adaptive streaming scenario.

### SUMMARY

The present disclosure is directed to provide an encoding/decoding method and apparatus for adaptive streaming and a transmitting method.

In addition, the present disclosure is directed to provide a quality allocation method for streaming an immersive image adaptively to a user's view.

In addition, the present disclosure is directed to independently divide and process each of immersive images to be processed, to align the images in an order of contribution, and then to encode an image of a view with a high degree of contribution in high quality.

In addition, the present disclosure is directed to adaptively determine a degree of contribution according to a distance between a view of immersive images and a user's view.

In addition, the present disclosure is directed to implement a quality allocation method in a view group unit capable of independent transmission and reconstruction.

In addition, the present disclosure is directed to generate bitstreams with various qualities and to select and transmit a bitstream corresponding to a determined degree of contribution.

In addition, the present disclosure is directed to generate and transmit a bitstream corresponding to a determined degree of contribution.

In addition, the present disclosure is directed to provide a method for transmitting a bitstream generated by an immersive image encoding method or apparatus according to the present disclosure.

In addition, the present disclosure is directed to provide a recording medium storing a bitstream generated by an immersive image encoding/decoding method or apparatus according to the present disclosure.

In addition, the present disclosure is directed to provide a recording medium storing a bitstream which is received and decoded by an image decoding apparatus according to the present disclosure and is used to reconstruct an immersive image.

Technical objects of the present disclosure are not limited to the above-mentioned technical objects, and other technical objects that are not mentioned will be clearly understood by those skilled in the art through the following descriptions.

An immersive image encoding method according to an aspect of the present disclosure, which is performed in an immersive image encoding apparatus, may include: grouping images for a virtual reality space into groups; calculating, based on view information, a view weight of each of the groups; and determining, based on the view weight, a bitstream level of the each of the groups.

An immersive image encoding apparatus according to an aspect of the present disclosure may include a memory and at least one processor, and the at least one processor may be configured to group images for a virtual reality space into groups, to calculate, based on view information, a view weight of each of the groups, and to determine, based on the view weight, a bitstream level of the each of the groups.

A method for transmitting a bitstream according to an aspect of the present disclosure, which is a method of transmitting a bitstream generated by an immersive image encoding method, may include: grouping images for a virtual reality space into groups; calculating, based on view information, a view weight of each of the groups; and determining, based on the view weight, a bitstream level of the each of the groups.

The features briefly summarized above with respect to the present disclosure are merely exemplary aspects of the detailed description below of the present disclosure, and do not limit the scope of the present disclosure.

According to the present disclosure, a transmission bandwidth may be reduced, while minimizing quality loss of a bitstream.

In addition, according to the present disclosure, an adaptive high-quality immersive image according to a user view may be transmitted through a more efficient bandwidth.

Effects obtained in the present disclosure are not limited to the above-mentioned effects, and other effects not mentioned above may be clearly understood by those skilled in the art from the following description.

### BRIEF DESCRIPTION OF THE DRAWINGS

FIG. 1 is a view showing a concept of a multi-view image in an immersive video according to an embodiment of the present disclosure.

FIG. 2A and FIG. 2B are views schematically showing TMIV (Test Model for Immersive Video) encoder and decoder according to an embodiment of the present disclosure.

FIG. 3 is a view schematically showing an immersive image streaming system to which embodiments of the present disclosure are applicable.

FIG. 4 is a flowchart showing an immersive image encoding method according to an embodiment of the present disclosure.

FIG. 5 is a flowchart showing a grouping method according to an embodiment of the present disclosure.

FIG. 6 is a view for explaining a method for removing redundancy between views and a method for generating an atlas according to an embodiment of the present disclosure.

FIG. 7 is a view for explaining a method for calculating a view weight according to an embodiment of the present disclosure.

FIG. 8 is a flowchart showing a method for selecting a bitstream according to an embodiment of the present disclosure.

FIG. 9 is a flowchart showing a method for generating a bitstream according to another embodiment of the present disclosure.

### DETAILED DESCRIPTION

Hereinafter, the embodiments of the present disclosure will be described in detail with reference to the accompanying drawings, so that they can be easily implemented by those skilled in the art. However, the present disclosure may be embodied in many different forms and is not limited to the exemplary embodiments described herein.

In the following description of the embodiments of the present disclosure, a detailed description of known configurations or functions incorporated herein will be omitted when it may make the subject matter of the present disclosure rather unclear. Also, in the drawings, parts not related to the description of the present disclosure are omitted, and like parts are designated by like reference numerals.

In the present disclosure, when a component is referred to as being “linked”, “coupled”, or “connected” to another component, it may encompass not only a direct connection relationship but also an indirect connection relationship through an intermediate component. Also, when a component is referred to as “comprising” or “having” another component, it may mean further inclusion of another component not the exclusion thereof, unless explicitly described to the contrary.

In the present disclosure, the terms first, second and the like are used only for the purpose of distinguishing one component from another, and do not limit the order or importance of components, etc. unless specifically stated otherwise. Thus, within the scope of the present disclosure, a first component in one embodiment may be referred to as a second component in another embodiment, and similarly a second component in one embodiment may be referred to as a first component in another embodiment.

In the present disclosure, components that are distinguished from each other are intended to clearly illustrate respective features, which does not necessarily mean that the components are separate. That is, a plurality of components may be integrated into one hardware or software unit, or a single component may be distributed into a plurality of hardware or software units. Thus, unless otherwise noted, such integrated or distributed embodiments are also included in the scope of the present disclosure.

In the present disclosure, components described in the various embodiments are not necessarily essential components, and some may be optional components. Accordingly, embodiments consisting of a subset of the components described in one embodiment are also included in the scope of the present disclosure. Also, an embodiment that includes other components in addition to the components described in the various embodiments is also included in the scope of the present disclosure.

In the present disclosure, “/” and “,” may be interpreted as “and/or”. For example, “A/B” and “A, B” may be interpreted as “A and/or B”. In addition, “A/B/C” and “A, B, C” may mean “at least one of A, B and/or C”.

In the present disclosure, “or” may be interpreted as “and/or”. For example, “A or B” may mean 1) only “A”, 2) only “B”, or 3) “A and B”. Alternatively, in the present disclosure, “or” may mean “additionally or alternatively”.

In the present disclosure, the terms image, video, immersive image and immersive video may be used interchangeably.

Hereinafter, embodiments of the present disclosure will be described in detail with reference to the accompanying drawings. In describing exemplary embodiments of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

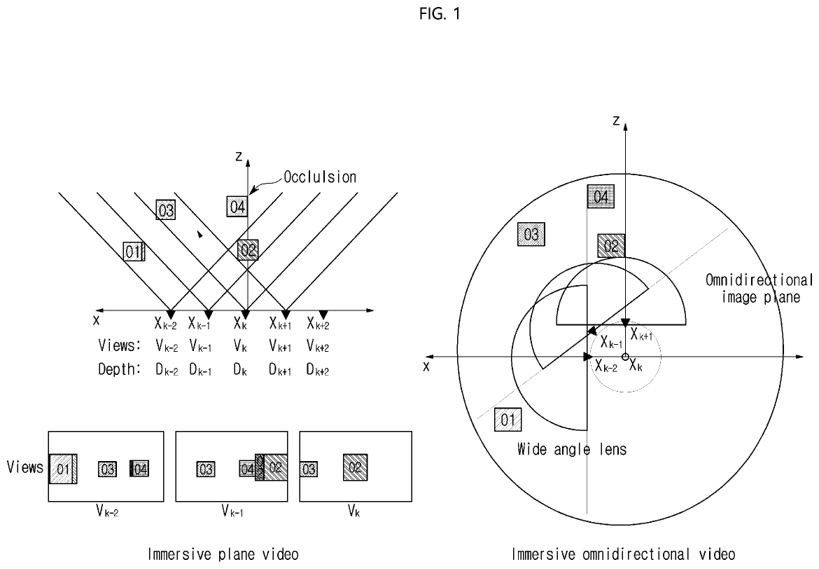

FIG. 1 is a view showing a concept of a multi-view image in an immersive video according to an embodiment of the present disclosure.

Referring to FIGS. 1, O1 to O4 may represent a region of an image in an arbitrary scene, Vk may represent an image obtained at a camera center position, Xk may represent a view position (camera position), and Dk may represent depth information at a camera center position.

In an immersive video, an image may be generated at a plurality of positions in various directions in order to support 6 DoF according to a user's movement. An immersive video may consist of an omnidirectional image and relevant spatial information (depth information, camera information). An immersive video may be transmitted to a terminal side through image compression and packet multiplexing processes.

An immersive video system may obtain, generate, transmit and reproduce a large immersive video consisting of multi views. Accordingly, an immersive video system should effectively store and compress massive image data and be compatible with an existing immersive video (3DoF).

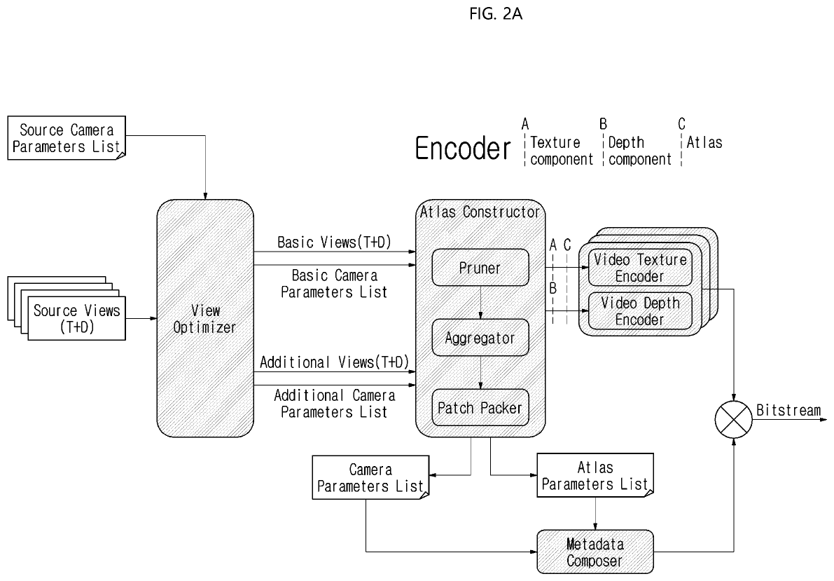

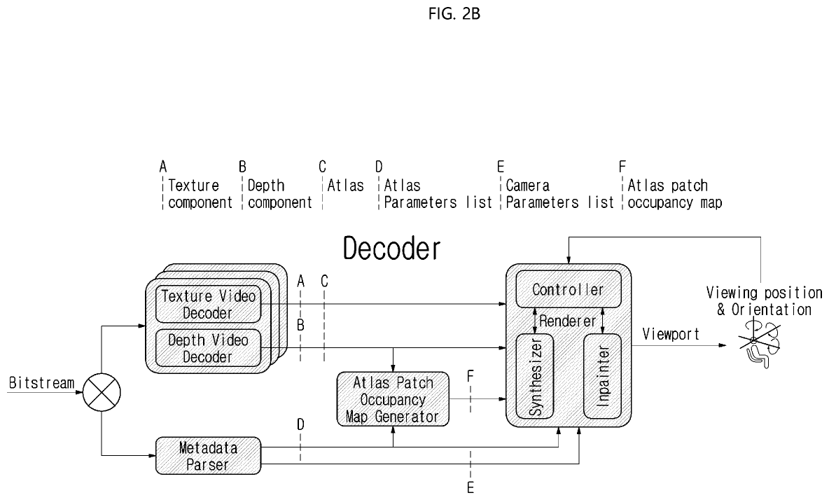

FIG. 2A and FIG. 2B are views schematically showing TMIV (Test Model for Immersive Video) encoder and decoder according to an embodiment of the present disclosure. Herein, a TMIV encoder may be an immersive image encoding apparatus, and a TMIV decoder may be an immersive image decoding apparatus.

Referring to FIG. 2A, an input of a TMIV encoder may be encoded sequentially through a view optimizer, an atlas constructor, a video texture encoder and a video depth encoder.

In a view optimizing process, the number of necessary basic views may be determined by considering a directional bias, a view. a distance, and an overlap of views. Next, in the view optimizing process, a basic view may be selected by considering a position and an overlap between views.

A pruner in the atlas constructor may preserve basic views by using a mask and remove an overlapping portion of additional views. An aggregator may update a mask used for a video frame in a chronological order.

Next, a patch packer may ultimately generate an atlas by packing each patch atlas. An atlas of a basic view may configure the same texture and depth information as the original one. An atlas of an additional view may have texture and depth information configured in a block patch form.

Referring to FIG. 2B, a TMIV decoder may reconstruct an atlas and a basic view for video texture and depth information. In addition, a finally reconstructed output may be generated through an atlas patch occupancy map generator and a renderer.

Specifically, the TMIV decoder may obtain a bitstream. In addition, texture and depth may be transmitted to the renderer via a texture video decoder and a depth video decoder. The renderer may be configured in three stages of controller, synthesizer and inpainter.

### Embodiment 1

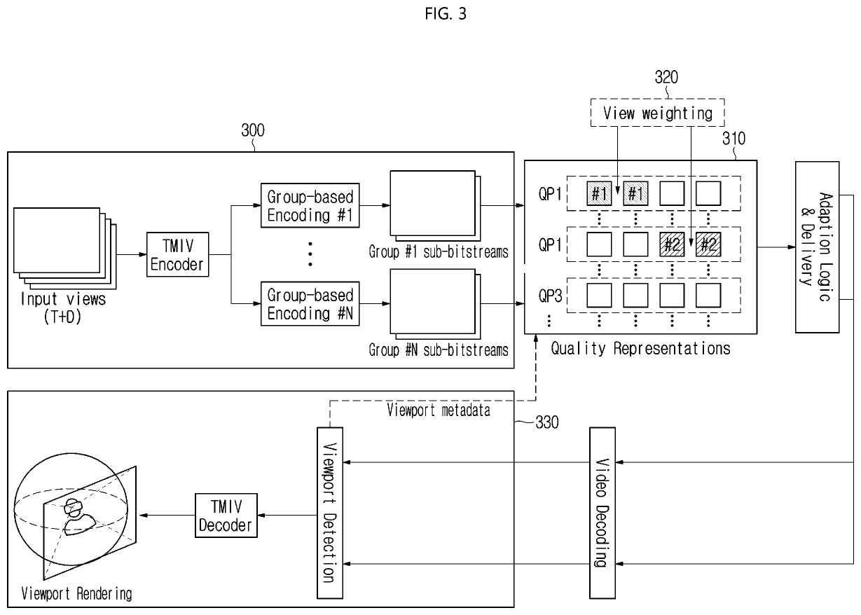

Embodiment 1 is an immersive image streaming system to which embodiments of the present disclosure are applicable. FIG. 3 is a view schematically showing an immersive image streaming system to which embodiments of the present disclosure are applicable.

Referring to FIG. 3, an immersive image streaming system may be configured by including a server device 300, a level adjuster 310, a weight calculator 320, a view detector 330, and a client device.

An immersive image encoding apparatus may be configured by including the server device 300, the level adjuster 310, and the weight calculator 320. An immersive image decoding apparatus may be configured by including the view detector 330 and a client device.

The server device 300 may obtain or store a plurality of immersive images (input views) available for an immersive image service. Immersive images may be a plurality of images representing a virtual reality space.

According to embodiments, the server device 300 may divide immersive images into images of a base view and images of an additional view. That is, the server device 300 may group immersive images into a base view image group and an additional view image group. When grouping immersive images, a ratio of each immersive image may be calculated to select a quality level.

The level adjuster 310 may adjust a quality level of a bitstream in which immersive images are rendered (encoded). As an example, the level adjuster 310 may generate a bitstream set by encoding immersive images in various levels of quality, and in this case, a bitstream selected according to an image type may be transmitted. Quality level adjustment of a bitstream may be performed based on view information described below.

The weight calculator 320 may calculate a degree of contribution (view weight) used for rendering an immersive image. Calculation of a view weight may be performed based on view information. View information may include first view information and second view information. First view information may be view information of immersive images, and second view information may be view information of a user.

According to embodiments, a view weight may be calculated based on a distance between first view information and second view information. As an example, a view weight may be calculated to be a larger value as a distance between first view information and second view information decreases. That is, a view weight may be calculated to be a smaller value as a distance between first view information and second view information increases.

In this case, a bitstream level of each group may be determined based on a value of a view weight. For example, as a value of a view weight calculated for a specific group is larger, a bitstream level for the group may be determined as a higher value. In addition, as a value of a view weight calculated for a specific group is smaller, a bitstream level for the group may be determined as a lower value.

The view detector 330 may detect second view information, which is view information of a user, and output it to the weight calculator 320 or the level adjuster 310. Second view information may be generated and detected based on a coordinate value for a user's view (that is, viewport) through an HMD used by the user.

A bitstream selected or generated may be transmitted to a client device via a transmitter (Adaption Logic & Delivery). A client device may reconstruct an immersive image by decoding received bitstreams and stream the reconstructed immersive image.

A reconstruction unit may reconstruct images from bitstreams by using image codecs like AVC (Advanced Video Coding), HEVC (High Efficiency Video Coding), and VVC (Versatile Video Coding).

A TMIV decoder may be a decoder to which TMIV, that is, a test model supporting the immersive image standardization technology, is applied, and 6DoF may be provided through a reconstructing operation of the TMIV decoder.

### Embodiment 2

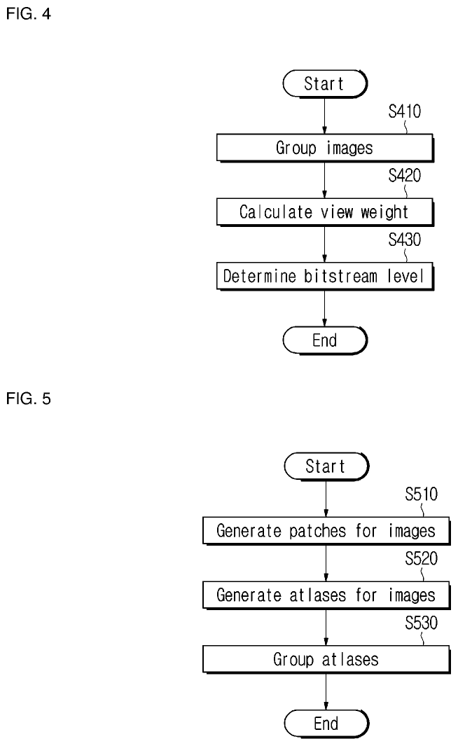

Embodiment 2 is an immersive image encoding method according to an embodiment of the present disclosure. FIG. 4 is a flowchart showing an immersive image encoding method according to Embodiment 2.

Referring to FIG. 4, an immersive image encoding apparatus may group immersive images into groups (S410). For example, the immersive image encoding apparatus may divide immersive images into different types of images. In this case, the immersive image encoding apparatus may divide immersive images into an image of base view and an image of additional view. That is, immersive images may be grouped into an image group of base view and an image group of additional view.

Based on view information, the immersive image encoding apparatus may calculate a view weight for each group (S420). The view information may include first view information and second view information, and the first view information may be view information of immersive images, and the second view information may be view information of a user.

For example, the immersive image encoding apparatus may calculate a relatively high view weight for a group including many images with a high degree of contribution and a relatively low view weight for a group including many images with a low degree of contribution.

Based on a view weight, the immersive image encoding apparatus may determine a bitstream level of each group, that is, a bitstream quality level of each group (S430). For example, a group, for which a relatively high view weight is calculated, may be determined with a relatively high bitstream level, and a group, for which a relatively low view weight is calculated, may be determined with a relatively low bitstream level.

According to embodiments, the immersive image encoding apparatus may determine a bitstream level further based on an available transmission bandwidth. For example, the immersive image encoding apparatus may determine a bitstream level of each group within a transmission bandwidth.

Information on a transmission bandwidth may be obtained from an immersive image decoding apparatus or be obtained by the immersive image encoding apparatus itself. A process of obtaining information on a transmission bandwidth may be performed before the process (S410) of grouping immersive image into groups.

For each group, the immersive image encoding apparatus may generate or select a bitstream corresponding to a determined bitstream level. For example, a group, which is determined with a relatively high bitstream level, may be generated or selected in a bitstream with relatively high quality, and a group, which is determined with a relatively low bitstream level, may be generated or selected in a bitstream with relatively low quality.

The immersive image encoding apparatus may transmit a bitstream thus generated or selected. According to embodiments, before transmitting a bitstream generated or selected, the immersive image encoding apparatus may modify metadata of the immersive image encoding/decoding apparatus according to the bitstream generated or selected.

The immersive image decoding apparatus may obtain the bitstream and provide an immersive image streaming service based on the obtained bitstream. Specifically, the immersive image decoding apparatus may reconstruct an immersive image by decoding bitstreams according to a bitstream level, which is determined in the process of S430, and stream the reconstructed immersive image.

### Embodiment 3

Embodiment 3 is a grouping method according to an embodiment of the present disclosure. FIG. 5 is a flowchart showing a grouping method according to Embodiment 3.

An immersive image encoding apparatus may generate patches for immersive images by removing an overlapping region between images of each group (S510). The process S510 may be a process for enabling each immersive image to be transmitted at an independent quality level by removing an overlap for a plurality of immersive images and thus making the immersive images independently processed.

The immersive image encoding apparatus may generate atlases for immersive images by packing the generated patches (S520). In addition, the immersive image encoding apparatus may group the atlases into groups (S530).

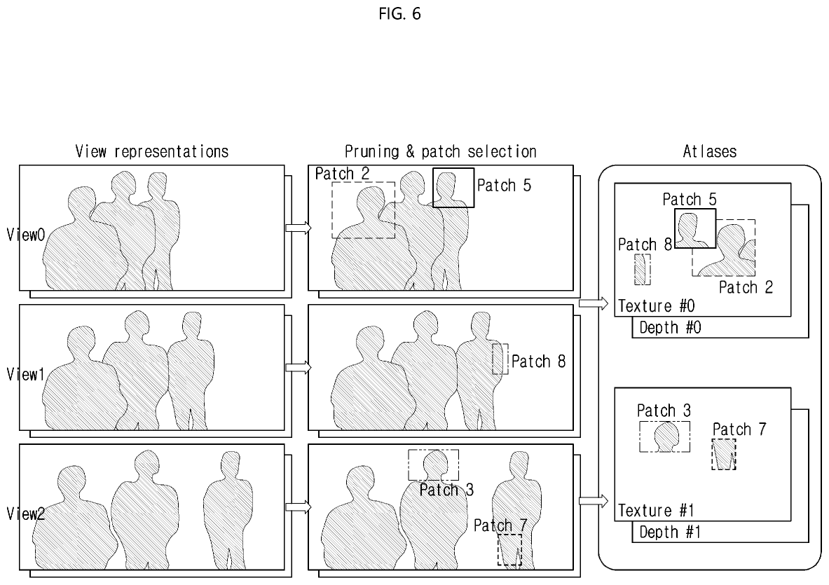

An example for a method of generating an atlas is illustrated in FIG. 6. Referring to FIG. 6, when an overlapping region among immersive images of different views (View 0, View 1, View 2) is removed, patches (Patch 2, Patch 5, Patch 8, Patch 3, Patch 7) may be generated. When an overlapping region of the immersive image View 0 is removed, Patch 2 and Patch 5 may be generated, when an overlapping region of the immersive image View 1 is removed, Patch 8 may be generated, and when an overlapping region of the immersive image View 2 is removed, Patch 3 and Patch 7 may be generated.

When the generated patches are packed according to texture and depth, atlases may be generated. For example, an atlas with Patch 2, Patch 5 and Patch 8 being packed may be generated as a packing result according to Texture #0 and Depth #0, and an atlas with Patch 3 and Patch 7 being packed may be generated as a packing result according to Texture #1 and Depth #1.

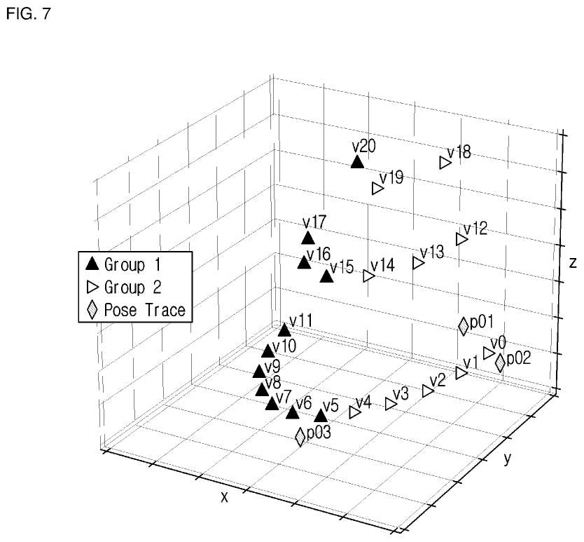

FIG. 7 is a view for explaining a method for calculating a view weight according to an embodiment of the present disclosure.

In FIG. 7, triangles turned 90 degrees clockwise indicate a view (that is, camera coordinate) of immersive images in Group 1, and triangles turned 0 degree clockwise indicate a view of immersive images in Group 2. In addition, rectangles indicate a user's view information p01, p02 and p03.

When rendering a user's view information like p01, p02 and p03, since p01 and p02 are located at a relatively closer distance to a view of immersive images in Group 1, it is possible to infer that they will be rendered mainly using immersive images of Group 1.

Accordingly, in case a user's view information is p01 or p02, a relatively large view weight may be calculated for Group 1, and a relatively small view weight may be calculated for Group 2.

From the same perspective, since p03 is located at a relatively closer distance to a view of immersive images in Group 2, it is possible to infer that it will be rendered mainly using immersive images of Group 2.

Accordingly, in case a user's view information is p03, a relatively large view weight may be calculated for Group 2, and a relatively small view weight may be calculated for Group 1.

### Embodiment 4

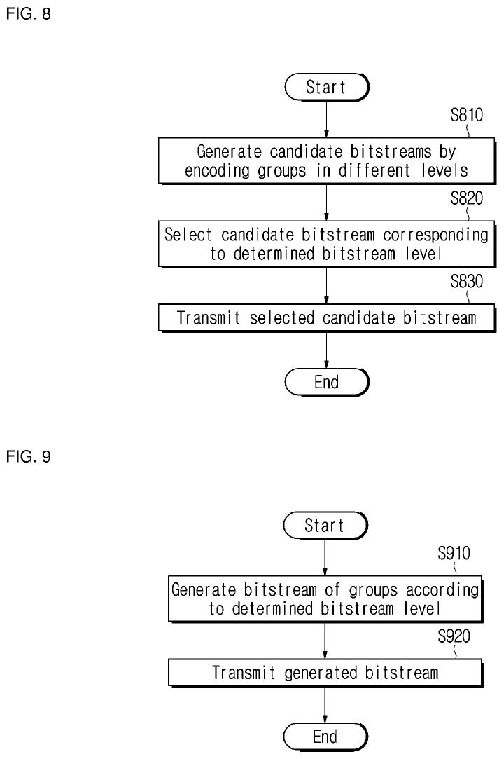

Embodiment 4 is a method of selecting a bitstream according to an embodiment of the present disclosure. FIG. 8 is a flowchart showing a method for selecting a bitstream according to Embodiment 4.

Referring to FIG. 8, an immersive image encoding apparatus may generate candidate bitstreams by encoding groups (or immersive images in each group) in different levels (S810). Candidate bitstreams thus generated may be stored in the server device 300.

For example, the immersive image encoding apparatus may encode each group in a plurality of quantization parameter (QP) values and generate and store them in a bitstream form. In FIG. 1, QP1, QP2 and QP3 may indicate a plurality of quantization parameters, #1 may indicate an immersive image that is encoded in QP1 value and is generated in a bitstream form, and #2 may indicate an immersive image that is encoded in QP2 value and is generated in a bitstream form.

When a bitstream level of each group is determined based on a view weight, the immersive image encoding apparatus may generate a candidate bitstream corresponding to the determined bitstream level or select the candidate bitstream among stored candidate bitstreams (S820). In addition, the immersive image encoding apparatus may transmit the selected candidate bitstream to an immersive image decoding apparatus (S830).

### Embodiment 5

Embodiment 5 is a method for generating a bitstream according to another embodiment of the present disclosure. FIG. 9 is a flowchart showing a method for generating a bitstream according to Embodiment 5.

Referring to FIG. 9, an immersive image encoding apparatus may determine a bitstream level of each group based on a view weight and generate a bitstream corresponding to the determined bitstream level for each group (S910). In addition, the immersive image encoding apparatus may transmit the selected candidate bitstream to an immersive image decoding apparatus (S920).

The embodiment described through FIG. 8 relates to a method of determining a (candidate) bitstream corresponding to a bitstream level after generating a candidate bitstream beforehand, and the embodiment described through FIG. 9 relates to a method of determining a bitstream corresponding to a bitstream level without generating a candidate bitstream beforehand.

### Test Result

A test was performed for a method proposed through the present disclosure.

The test was performed based on TMIV 6.0, which is a test model of MPEG-I, by complying with the common test condition (CTC). For test contents (immersive images for testing), 8 sequences of Museum (SB), Painter (SD), Frog (SE), Fan (SO), Group (SR), Carpark (SP), Street (SU), and Hall (ST) were selected.

Table 1 below shows calculated results of contribution (view weight) of user views p01, p02 and p03 respectively for the eight sequences for each group (G1, G2).

TABLE 1

| | | | p01 | p02 | p03 |
|---|---|---|---|---|---|
| | | Views | view | view | view |
| Class | Group | per group | weights | weights | weights |
| B | G1 | v1, v4, v2, v8, v18, | 51.84 | 44.80 | 52.14 |
| | | v7, v17, v9, v6, | | | |
| | | v22, v11, v21 | | | |
| | G2 | v5, v15, v13, v16, v10, | 49.26 | 55.20 | 47.86 |
| | | v12, v0, v3, v20, v19, | | | |
| | | v14, v23 | | | |
| D | G1 | v0, v4, v1, v5, v2, v8, | 64.95 | 81.00 | 76.19 |
| | | v6, v9 | | | |
| | G2 | v10, v3, v12, v13, v7, | 35.05 | 19.00 | 23.81 |
| | | 11, v14, v15 | | | |
| E | G1 | v0, v1, v2, v3, v4, v5 | 98.07 | 10.64 | 7.18 |
| | G2 | v6, v7, v8, v9, v10, | 1.93 | 89.36 | 92.82 |
| | | v11, v12 | | | |
| R | G1 | v0, v1, v12, v2, v13, v3, | 96.28 | 96.17 | 10.51 |
| | | v18, v14, v4, v19 | | | |
| | G2 | v5, v15, v6, v20, v16, v7, | 3.72 | 3.83 | 89.49 |
| | | v17, v8, v9, v10, v11 | | | |
| O | G1 | v14, v9, v13, v8, v4, | 80.99 | 36.14 | 55.88 |
| | | v12, v3 | | | |
| | G2 | v7, v2, v11, v6, v1, | 19.01 | 63.86 | 44.12 |
| | | v10, v5, v0 | | | |
| P | G1 | v8, v7, v6, v5 | 86.77 | 20.99 | 90.44 |
| | G2 | v4, v3, v2, v1, v0 | 13.23 | 79.01 | 9.56 |
| U | G1 | v8, v7, v6, v5 | 92.55 | 93.53 | 95.22 |
| | G2 | v4, v3, v2, v1, v0 | 19.01 | 19.01 | 19.01 |
| T | G1 | v8, v7, v6, v5 | 84.32 | 90.97 | 10.99 |
| | G2 | v4, v3, v2, v1, v0 | 15.86 | 9.03 | 89.01 |

In Table 1, the unit of view weights is %, and Class indicates classes of the eight sequences. Class B indicates the Museum class, Class D indicates the Painter class, Class E indicates the Flog class, Class R indicates the Fan class, Class O indicates the Group class, Class P indicates the Carpark class, Class U indicates the Street class, and Class T indicates the Hall class.

The results of Table 2 and Table 3 were derived by applying the view weights of Table 1 to the proposed method of the present disclosure.

TABLE 2

| | SB | SD | SE | SR | SO | SP | SU | ST |
|---|---|---|---|---|---|---|---|---|
| p01 | 46.6 | −9.7 | −18.9 | −12.0 | −13.6 | −11.5 | −19.6 | −21.4 |
| p02 | 48.8 | −8.8 | −22.7 | −9.6 | −11.5 | −10.4 | −15.0 | −17.7 |
| p03 | 43.2 | −5.4 | −21.3 | −6.7 | −3.5 | −13.5 | −14.7 | −18.2 |
| Avg. | 46.2 | −7.9 | −20.96 | −9.4 | −9.5 | −11.8 | −16.4 | −19.1 |

TABLE 3

| | SB | SD | SE | SR | SO | SP | SU | ST |
|---|---|---|---|---|---|---|---|---|
| p01 | 41.7 | −4.5 | −14.5 | −15.6 | −13.5 | −8.7 | −15.5 | −17.8 |
| p02 | 45.6 | −6.7 | −18.7 | −10.4 | −9.8 | −8.8 | −14.7 | −12.5 |
| p03 | 35.3 | 2.3 | −19.9 | −5.2 | −2.7 | −11.2 | −12.8 | −11.0 |
| Avg. | 40.8 | −2.9 | −17.7 | −10.4 | −8.6 | −9.5 | −14.3 | −13.7 |

Table 2 shows a peak signal-to-noise ratio (PSNR) of the proposed method of the present disclosure in comparison with the conventional method, and Table 3 shows an immersive video-PSNR (IV-PSNR) of the proposed method of the present disclosure in comparison with a conventional method. In Table 2 and Table 3, the unit of view weights is %.

As shown in Table 2 and Table 3, the proposed method of the present disclosure has 17% BD-rate reduction on average in PSNR as compared with the conventional method and has 14.6% BD-rate reduction on average in IV-PSNR as compared with the conventional method.

In the above-described embodiments, the methods are described based on the flowcharts with a series of steps or units, but the present disclosure is not limited to the order of the steps, and rather, some steps may be performed simultaneously or in different order with other steps.

In addition, it should be appreciated by one of ordinary skill in the art that the steps in the flowcharts do not exclude each other and that other steps may be added to the flowcharts or some of the steps may be deleted from the flowcharts without influencing the scope of the present disclosure.

The above-described embodiments include various aspects of examples. All possible combinations for various aspects may not be described, but those skilled in the art will be able to recognize different combinations. Accordingly, the present disclosure may include all replacements, modifications, and changes within the scope of the claims.

The embodiments of the present disclosure may be implemented in a form of program instructions, which are executable by various computer components, and recorded in a computer-readable recording medium. The computer-readable recording medium may include stand-alone or a combination of program instructions, data files, data structures, etc. The program instructions recorded in the computer-readable recording medium may be specially designed and constructed for the present disclosure, or well-known to a person of ordinary skilled in computer software technology field. Examples of the computer-readable recording medium include magnetic recording media such as hard disks, floppy disks and magnetic tapes; optical data storage media such as CD-ROMs and DVD-ROMs; magneto-optimum media like floptical disks; and hardware devices, such as read-only memory (ROM), random-access memory (RAM), flash memory, etc., which are particularly structured to store and implement program instructions. Examples of the program instructions include not only a mechanical language code formatted by a compiler but also a high level language code that may be implemented by a computer using an interpreter. The hardware devices may be configured to be operated by one or more software modules or vice versa to conduct the processes according to the present disclosure.

In the above-described embodiments, the methods are described based on the flowcharts with a series of steps or units, but the present disclosure is not limited to the order of the steps, and rather, some steps may be performed simultaneously or in different order with other steps. In addition, it should be appreciated by one of ordinary skill in the art that the steps in the flowcharts do not exclude each other and that other steps may be added to the flowcharts or some of the steps may be deleted from the flowcharts without influencing the scope of the present disclosure.

The above-described embodiments include various aspects of examples. All possible combinations for various aspects may not be described, but those skilled in the art will be able to recognize different combinations. Accordingly, the present disclosure may include all replacements, modifications, and changes within the scope of the claims.

The embodiments of the present disclosure may be implemented in a form of program instructions, which are executable by various computer components, and recorded in a computer-readable recording medium. The computer-readable recording medium may include stand-alone or a combination of program instructions, data files, data structures, etc. The program instructions recorded in the computer-readable recording medium may be specially designed and constructed for the present disclosure, or well-known to a person of ordinary skilled in computer software technology field. Examples of the computer-readable recording medium include magnetic recording media such as hard disks, floppy disks, and magnetic tapes; optical data storage media such as CD-ROMs or DVD-ROMs; magneto-optimum media such as floptical disks; and hardware devices, such as read-only memory (ROM), random-access memory (RAM), flash memory, etc., which are particularly structured to store and implement the program instruction. Examples of the program instructions include not only a mechanical language code formatted by a compiler but also a high level language code that may be implemented by a computer using an interpreter. The hardware devices may be configured to be operated by one or more software modules or vice versa to conduct the processes according to the present disclosure.

Although the present disclosure has been described in terms of specific items such as detailed elements as well as the limited embodiments and the drawings, they are only provided to help more general understanding of the disclosure, and the present disclosure is not limited to the above embodiments. It will be appreciated by those skilled in the art to which the present disclosure pertains that various modifications and changes may be made from the above description.

Therefore, the spirit of the present disclosure shall not be limited to the above-described embodiments, and the entire scope of the appended claims and their equivalents will fall within the scope and spirit of the disclosure.

What is claimed is:

1. A method for encoding an immersive image, which is implemented in an apparatus for encoding an immersive image, comprising:
grouping images for a virtual reality space into groups;
calculating, based on view information, a view weight of each of the groups; and
determining, based on the view weight, a bitstream level of the each of the groups.

2. The method of claim 1, wherein the images are grouped into an image group of base view and an image group of additional view.

3. The method of claim 1, wherein the grouping comprises:
generating patches for images by removing an overlapping region between the images in the each group;
generating atlases for the images by packing the patches; and
grouping the atlases into the groups.

4. The method of claim 1, wherein the view information includes first view information, which is view information of the images, and second view information that is view information of a user.

5. The method of claim 4, wherein the view weight of the each of the groups is calculated based on a distance between the first view information and the second view information.

6. The method of claim 5, wherein the view weight of the each of the groups is calculated to be a larger value as a distance between the first view information and the second view information become smaller.

7. The method of claim 1, wherein the bitstream level of the each of the group is determined as a higher bitstream level as a value of the view weight becomes larger.

8. The method of claim 1, further comprising selecting, among candidate bitstreams, a candidate bitstream corresponding to the determined bitstream level,
wherein the candidate bitstreams are generated by encoding the groups in different levels.

9. The method of claim 1, further comprising generating a bitstream by encoding the groups according to the determined bitstream level.

10. An apparatus for encoding an immersive image, the apparatus comprising:
a memory; and
at least one processor,
wherein the at least one processor is configured to:
group images for a virtual reality space into groups,
calculate, based on view information, a view weight of each of the groups, and
determine, based on the view weight, a bitstream level of the each of the groups.

11. A method for transmitting a bitstream generated by an immersive image encoding method, wherein the immersive image encoding method comprises:
grouping images for a virtual reality space into groups;
calculating, based on view information, a view weight of each of the groups; and
determining, based on the view weight, a bitstream level of the each of the groups.
